(19) United States
(12) Patent Application Publication
(10) Pub. No.: US 2016/0183317 A1
(43) Pub. Date: Jun. 23, 2016

(54) METHOD TO REDUCE USER PERCEIVED CONNECTION TIME FOR MIRACAST/WIDI

(71) Applicant: INTEL CORPORATION, SANTA CLARA, CA (US)

(72) Inventors: Lei SHAO, Sunnyvale, CA (US); Xintian E. LIN, Mountain View, CA (US); Ulun KARACAOGLU, San Diego, CA (US); Gary C. HUANG, San Jose, CA (US)

(21) Appl. No.: 14/581,311

(22) Filed: Dec. 23, 2014

(51) Int. Cl. H04W 76/02; H04W 8/00; H04L 29/06; H04W 4/00

(52) U.S. Cl. CPC H04W 76/023; H04W 4/008; H04W 8/005; H04L 65/4069

(57) ABSTRACT

Techniques for connecting using Miracast peer-to-peer communications are provided. Specifically, methods are presented, that when taken alone or together, provide a device or group of devices with an efficient way of streaming data from a source display onto the screen of a display device. The present disclosure includes a method that provides a more effective means for screencasting by using a pre-connect and stream mechanism.

### TECHNICAL FIELD

Embodiments pertain to wireless networks. Some embodiments relate to wireless networks that operate in accordance with Wi-Fi Peer-to-Peer (P2P) Technical Specification v1.5. Some embodiments relate to communicating with one or more devices. Some embodiments relate to the communicating using Miracast® via a Wi-Fi Direct® connection.

### BACKGROUND

As users are becoming more and more dependent on their wireless electronics, seamless transitions between the devices is expected. As such, an ad hoc network where two or more devices can communicate without involvement of an access point is an asset. Thus, using a Wi-Fi Direct® connection such as Miracast® for peer-to-peer communication is advantageous, as Miracast® can effectively be used to mirror content stored on one device to another.

Miracast® is a wireless display standard that enables wireless delivery of audio, video and other content from a source device to a display device without the need for the devices to be on the same network. For example, with Miracast® a user can echo display from a tablet onto a conference projector. However, the current standard architecture is designed such that connectivity between the source and display devices occurs only upon request of a user. This user dependent architecture provides the user with the ability to enable Miracast® screencasting which initiates the scan, connect and streaming process.

A number of issues arise from this architecture. One such issue is the user involvement required to initiate the process. A display device scan does not start until a user input is detected. Another issue includes the need for a second user input to select the device from the list of devices identified from the scan to establish connection and begin streaming. Still another issue that arises from this architecture is the user perceived delay before the content from the source device is viewed on the display device. Such perceived delay could possibly exceed 10 seconds. It is with these and other considerations that the present improvements have been developed.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an exemplary communication system using Miracast® screencasting;

FIG. 2 illustrates an exemplary wireless device;

FIG. 3 illustrates an exemplary block diagram of a Miracast® “Scan+Connect” technique;

FIG. 4 illustrates an exemplary block diagram of a “Pre-Connect+Stream” technique;

FIG. 5 illustrates an exemplary embodiment of background event trigger in a Miracast® communication system and device scan; and

FIG. 6 is a flowchart illustrating pre-connect and stream technique for Wireless Display (WiDi) connection.

### DESCRIPTION OF EMBODIMENTS

Embodiments may be implemented as part of the Institute of Electrical and Electronics Engineers (IEEE) 802.11 standards including the IEEE 802.11-2012 standards. Embodiments may be implemented as part of Wi-Fi Alliance® Technical Committee Hotspot 2.0 Technical Task Group Hotspot 2.0 (Release 2) Technical Specification, Version 2.04, Jan. 2, 2013. Embodiments may also be implemented as part of the Wi-Fi Alliance® Wi-Fi Direct® using Wi-Fi Peer-to-Peer Services Technical Specification v1.1 and Wi-Fi Peer-to-Peer (P2P) Technical Specification v1.5. However, the embodiments are not limited to 802.11 standards, Hotspot 2.0, Wi-Fi and Wi-Fi Direct® standards. Embodiments can be used in implementation with other wireless communications standards and the like.

In the following detailed description, numerous specific details are set forth in order to provide a thorough understanding of the disclosed techniques. However, it will be understood by those skilled in the art that the present embodiments may be practiced without these specific details. In other instances, well-known methods, procedures, components and circuits have not been described in detail so as not to obscure the present disclosure.

Although embodiments are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, a communication system or subsystem, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, circuits, or the like.

Before undertaking the description of embodiments below, it may be advantageous to set forth definitions of certain words and phrases used throughout this document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, interconnected with, contain, be contained within, connect to or with, couple to or with, be communicable with, cooperate with, interleave, juxtapose, be proximate to, be bound to or with, have, or the like; and the term “controller” means any device, system or part thereof that controls at least one operation, such a device may be implemented in hardware, circuitry, firmware or software, or combination of at least two of the same. It should be noted that the functionality associated with any particular controller may be centralized or distributed, whether locally or remotely. Definitions for certain words and phrases are provided throughout this document and those of ordinary skill in the art should understand that in many, if not most instances, such definitions apply to prior, as well as future uses of such defined words and phrases.

The exemplary embodiments will be described in relation to communications systems, as well as protocols, techniques, means and methods for performing communications, such as in a wireless network, or in general in any communications network operating using any communications protocol(s). Examples of such are home or access networks, wireless home networks, wireless corporate networks, and the like. It should be appreciated however that in general, the systems, methods and techniques disclosed herein will work equally well for other types of communications environments, networks and/or protocols.

For purposes of explanation, numerous details are set forth in order to provide a thorough understanding of the present techniques. It should be appreciated however, that the present disclosure may be practiced in a variety of ways beyond the specific details set forth herein. Furthermore, while the exemplary embodiments illustrated herein show various components of the system collocated, it is to be appreciated that the various components of the system can be located at distant portions of a distributed network, such as a communications network, node, and/or the Internet, or within a dedicated secured, unsecured, and/or encrypted system and/or within a network operation or management device that is located inside or outside the network. As an example, a wireless device can also be used to refer to any device, system or module that manages and/or configures or communicates with any one or more aspects of the network or communications environment and/or transceiver(s) and/or stations and/or access point(s) described herein.

Thus, it should be appreciated that the components of the system can be combined into one or more devices, or split between devices, such as a transceiver, an access point, a station, a Domain Master, a display device, a network operation or management device, a node or collocated on a particular node of a distributed network, such as a communications network. As will be appreciated from the following description, and for reasons of computational efficiency, the components of the system can be arranged at any location within a distributed network without affecting the operation thereof.

Furthermore, it should be appreciated that the various links, including the communications channel(s) connecting the elements can be wired or wireless links or any combination thereof, or any other known or later developed element(s) capable of supplying and/or communicating data to and from the connected elements. The term module as used herein can refer to any known or later developed hardware, circuitry, software, firmware, or combination thereof, that is capable of performing the functionality associated with that element. The terms determine, calculate, and compute and variations thereof, as used herein are used interchangeable and include any type of methodology, process, technique, mathematical operation or protocol.

Moreover, while some of the exemplary embodiments described herein are directed toward a transmitter portion of a transceiver performing certain functions, this disclosure is intended to include corresponding and complementary receiver-side functionality in both the same transceiver and/or another transceiver(s), and vice versa.

Presented herein are embodiments of systems, processes, data structures, user interfaces, etc. The embodiments may relate to a communication device and/or communication system. The communication system can include Wi-Fi Direct® connections. The Wi-Fi Direct® connection can include a peer-to-peer communication and association between two or more networks or network devices. The overall design and functionality of the system described herein is, as one example, to provide a more efficient means for a device to connect to Miracast® enabled devices for screencasting.

Embodiments provide novel networking mechanisms that facilitate a more user friendly and efficient process for connecting and streaming data between two or more devices. The embodiments generally repartition the Miracast® architecture by scanning, detecting, and connecting to Miracast® enabled devices prior to receiving a user input requesting the streaming of information from a source or wireless device onto a display or sink device. As a result, a faster and less cumbersome connection is achieved while improving user experience by decreasing user perceived delay between user input and the display of information onto the display device. Other advantages exist as well as will be discussed herein.

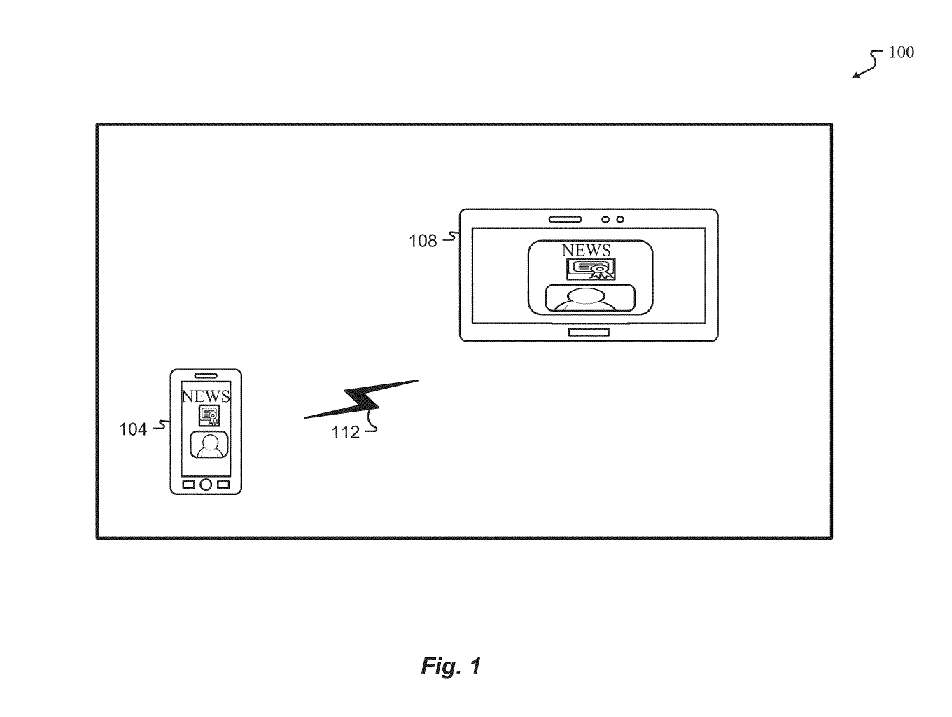

A general communication system 100 using Miracast® peer-to-peer communications is shown in FIG. 1. The communication system 100 can contain various devices which work together to deliver wireless audio and video screencasting or other information via communication channel 112. In general, various techniques and configurations are available for a source or a wireless device 104 to communicate with a display device or sink 108. Further, the transmitting or wireless device 104 and the receiving or display device 108 can support Miracast® or other comparable technology. The display device 108 can include but is not limited to desktops, tablets, mobile phones, TVs, projectors and other devices. In one example, the wireless device 104 can be used to display a presentation at a meeting on the display device 108 such as a projector. In another example, a home owner watching a football game on a wireless device 104 such as a smart phone can screencast the game onto their home TV.

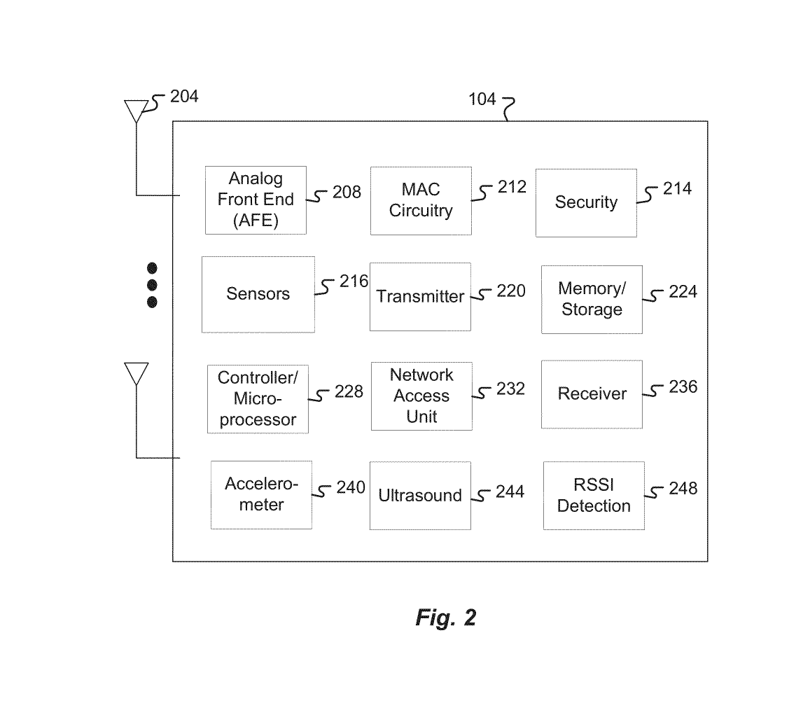

An example of a wireless device 104 architecture is shown in FIG. 2. The wireless device 104 may comprise hardware circuitry and/or software that conduct various operations. The operations can include, but are not limited, conducting calls, synchronizing with display device 108, opening multiple applications, presenting information through audio and/or video means, taking pictures, communicating via a Miracast®/WiDi connection, etc. The wireless device 104 can be any type of computing system operable to conduct the operations described herein. As an example, the wireless device 104 can be for example, a smart phone, laptop, tablet or portable computing device, which includes and interacts with various modules and components 208-248 as shown in FIG. 2.

The wireless device 104 can have one more antennas 204, for use in wireless communications such as multi-input multi-output (MIMO) communications, Bluetooth®, etc. The antennas 204 can include, but are not limited to directional antennas, omnidirectional antennas, monopoles, patch antennas, loop antennas, microstrip antennas, dipoles, and any other suitable for communication transmission. In an exemplary embodiment, transmission using MIMO may require particular antenna spacing. In another exemplary embodiment, MIMO transmission can enable spatial diversity allowing for different channel characteristics at each of the antennas. In yet another embodiment, MIMO transmission can be used to distribute resources to multiple users.

Antennas 204 generally interact with an Analog Front End (AFE) module 208, which is needed to enable the correct processing of the received modulated signal. The AFE 208 can sit between the antenna and a digital baseband system in order to convert the analog signal into a digital signal for processing.

The wireless device 104 can also include a controller/microprocessor 228 and a memory/storage 224. The wireless device 104 can interact with the memory/storage 224 which may store information and operations necessary for configuring and transmitting or receiving the message frames described herein. The memory/storage 224 may also be used in connection with the execution of application programming or instructions by the controller/microprocessor 228, and for temporary or long term storage of program instructions and/or data. As examples, the memory/storage 224 may comprise a computer-readable device, RAM, ROM, DRAM, SDRAM or other storage devices and media.

The controller/microprocessor 228 may comprise a general purpose programmable processor or controller for executing application programming or instructions related to the wireless device 104. Further, controller/microprocessor 228 can perform operations for configuring and transmitting message frames as described herein. The controller/microprocessor 228 may include multiple processor cores, and/or implement multiple virtual processors. Optionally, the controller/microprocessor 228 may include multiple physical processors. By way of example, the controller/microprocessor 228 may comprise a specially configured Application Specific Integrated Circuit (ASIC) or other integrated circuit, a digital signal processor, a controller, a hardwired electronic or logic circuit, a programmable logic device or gate array, a special purpose computer, or the like.

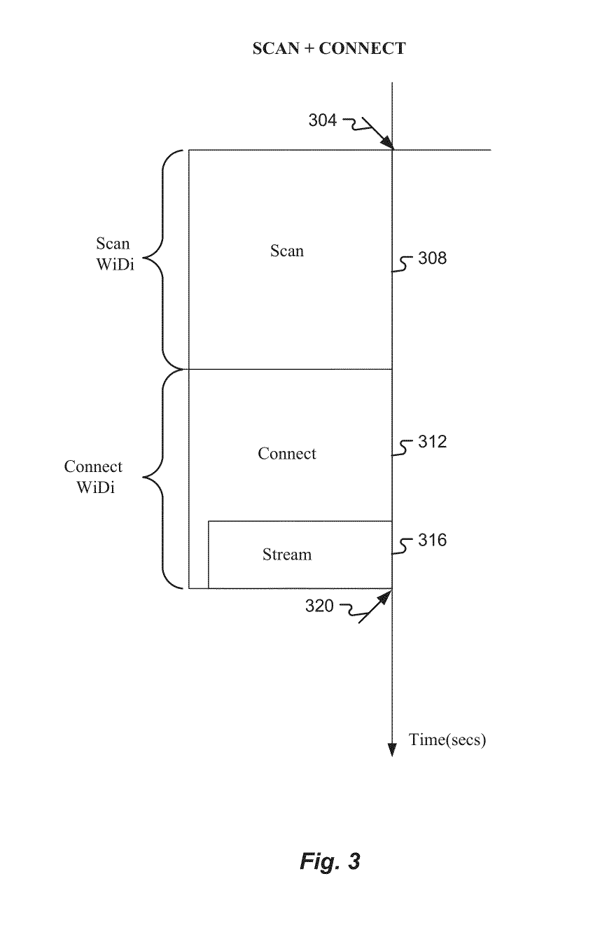

The wireless device 104 can further include a transmitter 220 and receiver 236 which can transmit and receive signals, respectively, to and from other wireless devices 104 or display devices 108 using one or more antennas 204. Included in the wireless device 104 circuitry is the medium access control or MAC Circuitry 212. MAC circuitry 212 provides the medium for controlling access to the wireless medium. In an exemplary embodiment, the MAC circuitry 212 may be arranged to contend for a wireless medium and configure frames or packets for communicating over the wireless medium. The MAC circuitry 212 can work together or independently of the sensors module 216, which can aid in identifying the location of the wireless device 104 while the wireless device 104 is stationary or in motion. The sensors module 216, can but is not limited to, providing a wireless device 104 with a prompt announcing the existence of display devices 108 or other similar communication devices in the vicinity of the wireless device 104. The display devices 108 and other communication devices can be sensed and detected using, for example, Wi-Fi communications, Bluetooth® communications, NFC communications, etc. In one example, the user can walk into a conference room, and via the badge access reader obtain location information on the wireless device 104. In another example, the sensors module 216 is used to scan and detect Wireless Display (WiDi) enabled devices for communication. The sensors module 216 can also work jointly or independently of an accelerometer 240, to determine wireless device location. The accelerometer 240 can primarily be responsible for, among other things, detecting the location/relocation/orientation of the wireless device 104. That is to say, if the wireless device 104 is in motion, the accelerometer 240 would provide details on the motion detected and even distance of movement. Therefore, with the movement information and sensor details, the wireless device 104 can obtain a better estimate of the display devices 108 available within the vicinity for connection. Further details regarding the connectivity of the wireless device 104 with display devices 108 is described below and in conjunction with FIGS. 3-6.

An RSSI (Received Signal Strength Indication) detection module 248 can also work jointly with the accelerometer 240 to detect and filter WiDi enabled display devices 108. In the RSSI detection module 248, the RSSI values for the detected devices are read and measured against a pre-determined threshold value. This comparison allows the wireless device 104 to eliminate those devices that are not within the vicinity of the wireless device 104 because their RSSI value is too low and thus not likely within a circumference of the wireless device 104 for screencasting.

The wireless device 104 can further contain an ultrasound monitoring module 244. The ultrasound monitoring module 244 can include, but is not limited to Bluetooth® Ultrasound technology, recording capabilities and other similar monitoring components that can provide feedback to the wireless device regarding the ultrasound recorded from the display device(s) 108. For example, the ultrasound monitoring module 244 can be used to send an ultrasound request to display devices 108 in the vicinity, and listen for a response from those display device(s) 108 within the same room or within a certain proximity.

The wireless device 104 can also contain a security module 214. The security module 214 can contain information regarding but not limited to, security parameters required to connect the wireless device 104 to display device 108 or other available devices and/or networks, and can include WEP or WPA security access keys, network keys, etc. The WEP security access key is a security password used by Wi-Fi networks. Knowledge of this code will enable the wireless device 104 to exchange information with the display device 108. The information exchange can occur through encoded messages with the WEP access code often being chosen by the network administrator. WPA is an added security standard that is also used in conjunction with network connectivity with stronger encryption than WEP.

Another module that the wireless device 104 can include is the network access unit 232. The network access unit 232 can be used for connectivity with the display device 108. In one exemplary embodiment, the connectivity can include synchronization between devices. In another exemplary embodiment, the network access unit 232 can work as a medium which provides support to the sensors module 216 for connecting via Miracast®. In yet another embodiment, the network access unit 232 can work in conjunction with at least the MAC circuitry 212. The network access unit 232 can also work and interact with one or more of the modules described herein.

The modules described and others known in the art can be used with the wireless device 104 and can be configured to perform the operations described herein in conjunction with FIG. 1 and FIGS. 3-6.

FIG. 3 is an exemplary block diagram of a Miracast® “Scan+Connect” technique. As part of the Miracast® wireless display standard, a wireless device 104 is able to connect with a display device 108 by completing a series of steps including scan 308, connect 312 and stream 316. In this technique, the wireless device 104 is directly controlled by the user and begins connectivity upon the detection of a user input 304. The user input 304 triggers the wireless device 104 to commence scanning 308 for Miracast® enabled devices. In one example, the wireless device 104 can be a WiDi enabled device scanning for WiDi enabled display devices 108. The display device 108 can be a projector, tablet, laptop, TV, etc. Once one or more of the display devices 108 are located, the wireless device can initiate connection with the one or more devices. In one example, the wireless device 104 can present a user with the option to select from the list of display devices 108 located for connection. Upon receipt of the user input selecting the desired device, the wireless device 104 would move forward with the connection 312. In another example, the wireless device 104 connects 312 to the various WiDi enabled display devices 108 identified. Due to Miracast's® ability to create an ad-hoc network, the identified devices are not required to be on the same network as the wireless device 104 and thus can connect and communicate with the wireless device 104 without the required association with a Wi-Fi/WLAN network. The wireless device proceeds to stream 316 the data from the wireless device 104 onto the one or more display devices 108 (i.e., projectors) and display the content 320.

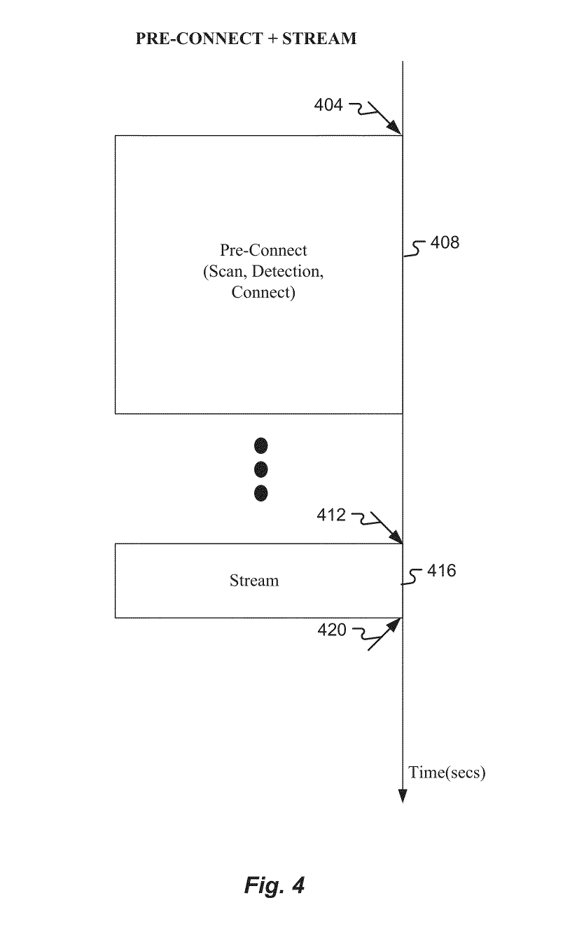

FIG. 4 is an exemplary block diagram of a “Pre-Connect+Stream” technique. In this embodiment, the standard “Scan+Connect” technique presented above and in conjunction with FIG. 3 is modified. This technique reparations the Miracast® architecture such that a pre-connect step 408, which includes, at least, scan, location detection and connection, occurs in the background prior to a user input 412.

The “Pre-Connect+Stream” technique presented in FIG. 4, includes a background-event trigger 404, a pre-connect 408 and stream 416 step. Screencasting using this technique is initiated by a background-event trigger 404. The background-event trigger 404 can be any one or more of the following events, such as but not limited to: a sensor trigger, an accelerometer trigger, an audio DSP trigger, a location trigger, proximity trigger, device detection trigger, a timer, etc. For example, if the wireless device 104 is moved from an office to a conference room, the accelerometer can be the background trigger. The accelerometer initiates the scan process for WiDi enabled devices since the new location will contain different display devices 108 on which to echo. To confirm that the movement of the wireless device 104 is substantial enough such that new WiDi enabled devices are required to be identified, device displacement is measured. If the wireless device relocation exceeds a pre-determined value, the device scan will begin. In other words, movement of the wireless device 104 will be a background trigger that initiates the “Pre-Connect+Stream” technique, however the scan will begin only upon a determination that the wireless device 104 has moved sufficiently far enough to require a new scan. Another example of a background trigger can be an audio DSP, which can periodically sense a room for WiDi enabled devices. By conducting periodic sensing, the audio DSP can provide a power efficient means for locating WiDi enabled display devices 108 without a required user input. Yet another example of a background trigger can be the detection of new WiFi hotspots, as a new set of hotspots are detected, a new set of WiDi enabled devices are likely to be found and thus a new scan should take place. Yet still another example can include the detection of an RFID key located at a door entrance, auditorium, etc. Other background triggers can also include a location change detected by a GPS, HID related devices/readers/scanners, an NFC transaction, a QR code scanned, and other similar triggers.

Once the “Pre-Connect+Stream” technique is initiated, the display device 108 automatically begins to scan for display devices 108, using for example, Bluetooth® Low Energy (BLE) detection, Wi-Fi, or other similar processes which can search for specific Universally Unique Identifiers (UUID). A list of identified devices from the scan is collected and the list is next narrowed to include only those display devices 108 within proximity of the wireless device 104. This detection can be completed for example, by reading the Received Signal Strength Indicators (RSSI) of the display devices 108. The RSSI can be used as an indication of the display device 108 location, the greater the signal strength measured, the closer the proximity to the wireless device 104. The scan could be further narrowed in an effort to only detect in-room devices by setting the RSSI at a threshold and then only identifying devices that exceed the RSSI threshold. To assist with this granularity, the threshold can optionally be user customizable, such as through a user interface to adjust the value to see more/less devices.

To further filter the identified display devices 108 down, an ultrasound request can automatically be transmitted by the wireless device 104 to the display devices 108. This ultrasound request can provide the information required to filter the list of displayed devices, for example, to only those in-room (in the same room as the device). If the wireless device 104 receives a response from the display device 108, the display device 108 is in the same room as the wireless device 104. Alternatively, if no response is received, the device is removed from the list as not being present in the room. The ultrasound response can be analyzed by an audio DSP for power saving or traditional codec+CPU methods can be used. Once the list has been narrowed down, connection can be initiated such that all the layers (i.e., PHY, MAC, IP, etc.) required for connectivity are connected and ready to streaming.

The display device(s) 108 will continue upon detection of a user input 412. Once the user input is detected, for example by a user selecting a device from a list of devices that were detected and saved as being available, the streaming process 416 begins and a mirror of the information on the wireless device 104 is projected/displayed/played on the display device(s) 108 selected.

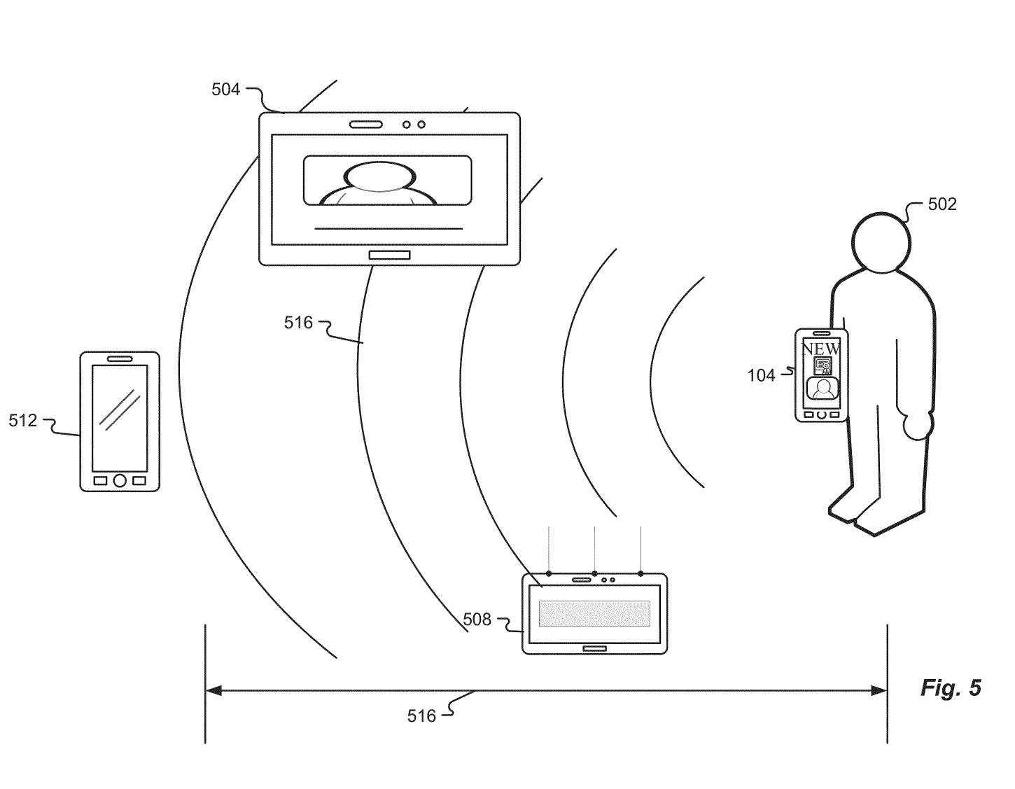

FIG. 5 is an exemplary embodiment of background event triggers in a Miracast® communication system and device scan. In a Miracast® system where a reparation architecture exists using the “Pre-Connect+Stream” technique, background-events can trigger the scan and connection process for WiDi enabled devices without user input. This technique as explained above and in conjunction with FIG. 4 can include user movement, sensors, other devices and/or actions to trigger this technique. Examples of such triggers leading to connection are exemplified in FIG. 5. For example, a first trigger can include user 502 who is using and carrying a wireless device 104. The movement of the wireless device 104 initiates the accelerometer within the wireless device 104 which can measure a distance traveled by the wireless device 104 signifying the need to establish a connection with display devices 104 at the new location. In response, the wireless device begins scanning the vicinity for display devices 108. The display devices 108 can be located using BLE (Bluetooth® Low Energy), NFC (Near-Field Communication), Wi-Fi and other similar network communications. The display devices 108 identified from the scan can include projectors 504, tablets 512, stations 508 and other similar Wi-Di enabled devices. In some instances, the display devices 108 identified can be within a proximity of the wireless device 104, however not within the circumference of a room or distance 516 in which the user 502 would like to screencast. To eliminate those devices outside the desired area or outside the location within a certain proximity, the wireless device 104 can transmit an ultrasound request 516 where only those display devices 108 (i.e., station 508 and projector 504) that respond are maintained as desirable devices to connect to and have a location within a certain proximity of the wireless device 104. Those devices who do not respond (i.e., tablet 512) are eliminated from the list of located devices. Once those devices are identified, the process continues as described above and in conjunction with FIG. 4.

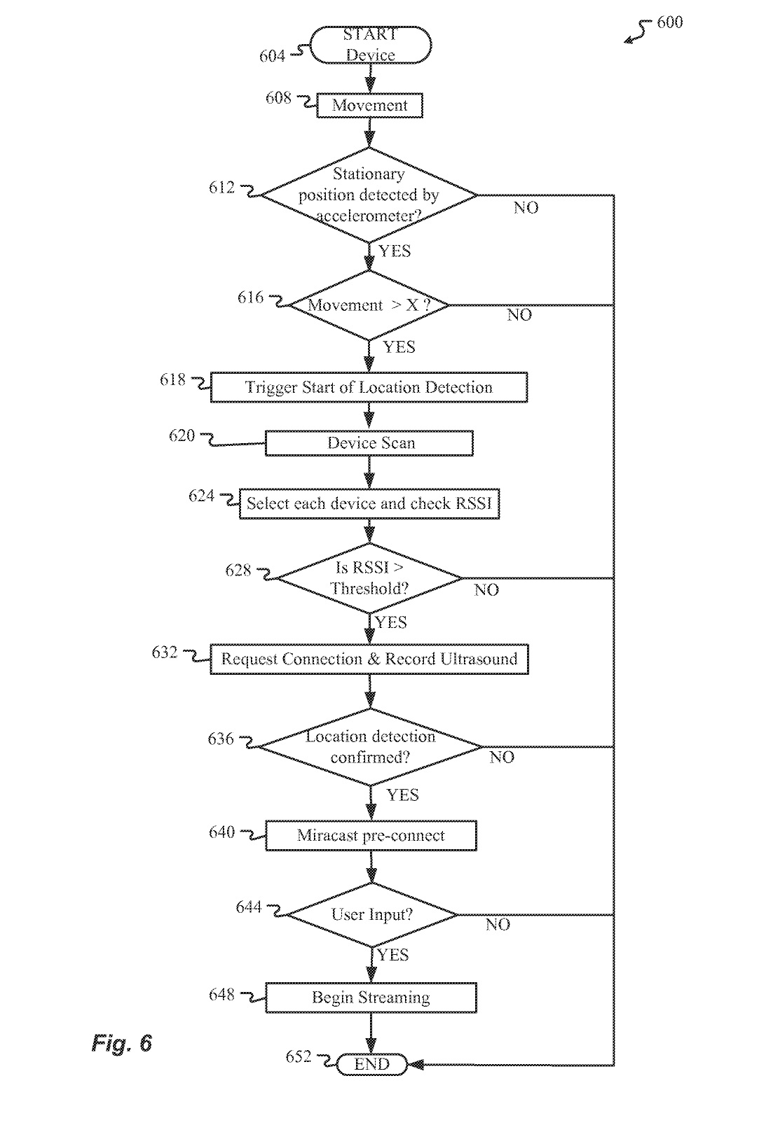

FIG. 6 outlines an exemplary flowchart illustrating the “Pre-Connect+Stream” technique for WiDi connection. The wireless “Pre-Connect+Stream” technique is a repartitioned architecture which includes a background event trigger, a pre-connect and stream steps. The background event trigger can include for example, a motion sensor (i.e. accelerometer). In one example, association begins at step 604 and continues to step 608. In step 608 an accelerometer is triggered by movement of the wireless device. The accelerometer continues to sense in step 612, if the accelerometer detects a stable transition from a walking position to a stationary position, the process will continue to step 616. Alternatively, if movement has not made the stable transition to a stationary position, the process ends at step 652. At step 616, the accelerometer ensures that the movement of the wireless device exceeds a pre-determined value X. The pre-determined value X can work to help eliminate unnecessary connections what would be triggered every time the wireless device is moved even if minimal movement occurred. As an example, the movement of a tablet from one location on a desk to another would not meet the pre-determined distance such that a new connection would be necessary, and the process ends in step 652. As another example, if the tablet or wireless device is picked up and taken with to a meeting, then in that instance the threshold X could be met and a new connection required and the process continues to step 618.

At step 618, both conditions in the background event are met such that the location/proximity detection is triggered. Step 620, is where the area is scanned for devices in the vicinity. For example, the area can be scanned with Bluetooth® Low Energy and/or WiFi to find wireless projectors or TVs with proximity room sensor capability through specific Universally Unique Identifier (UUID) search. Scan step 620 is the first step of three steps (i.e., scan, location detection, and connect) within the pre-connect process of the repartitioned “Pre-Connect+Stream” technique.

Once the device scan is complete and the devices in the vicinity are located, the process continues to location detection in step 624, which can include for example, in-room detection. Location/proximity detection begins at step 624, where the detected devices' Received Signal Strength Indicator (RSSI) are checked against a threshold value. By checking the device RSSI, the list of detected by the scan devices is filtered down to the one or more devices whose RSSI exceeds a threshold, at step 628. If the display device RSSI does not exceed the threshold, then that device is eliminated from the list by step 652 and the next device is checked. Alternatively, if the display device 108 is selected, checked, and meets the condition in step 628, the process continues to step 632. At step 632, the wireless device requests a connection and records for an ultrasound response. For example, an in-room detection application on a wireless device can send an ultrasound request to room-sensors which can reside inside the wireless projectors or TVs. By listening for an ultrasound response, the wireless device for example, is able to determine if the display device(s) are in the same room. The ultrasound response can be analyzed by an audio DSP for power saving. If the recorded ultrasound is qualified, (i.e., in-room detection is confirmed) in step 636, the process continues to the connect step, in step 640. Alternatively, if no ultrasound response is receive, that device(s) is eliminated and the process ends for the device(s) at step 652. The connect step 640, pre-connection to set up all layers (i.e., PHY, MAC, etc.) of Miracast for streaming occurs.

At this point, the wireless device has completed the pre-connect step and awaits user input in step 644. If no input is detected, the process ends at step 652. Alternatively, if an input is detected, the streaming process will begin in step 648 and continue to display content until process ends at step 652. Further, details regarding the “Pre-Connect+Stream” technique described herein are further described above and in conjunction with FIGS. 1-5. This technique is not limited to Wi-Fi Direct® applications, the same technique can be applied to IP-based mirroring applications such as but not limited to Splashtop, MirrorOp, VNC, RDP, etc.

Embodiments are thus directed toward a device for communicating with sink devices, comprising: a memory; a transceiver; and a processor, the processor configured to: sense a background event, wherein the background event triggers proximity detection for a pre-connect process comprising: automatically scan a location proximity to the device for device discovery of one or more sink devices; automatically identify the one or more sink devices found by the scan within the location proximity of the device; automatically wirelessly connect to at least one sink device of the one or more sink devices identified to have the location proximity to the device; and stream to the at least one sink device. Aspects of the above device include wherein the sink devices are one or more of a display device, a projector, a speaker, a laptop, a tablet, or a television. Aspects of the above device include wherein the background event is based on a motion sensor, wherein the motion sensor is an accelerometer that senses device movement. Aspects of the above device include wherein the device movement sensed is a distance greater than a pre-determined distance. Aspects of the above device include wherein the background event includes information from a timer. Aspects of the above device include wherein scanning for the one or more sink devices includes searching for a specific Universally Unique Identifier (UUID). Aspects of the above device include wherein the location proximity to the device is in the same room as the device. Aspects of the above device include wherein identifying the one or more sink devices includes checking an Received Signal Strength Indicator (RSSI) value of the one or more sink devices, wherein the one or more sink devices with the RSSI value above a threshold is identified as a candidate to connect to and is at least one sink device. Aspects of the above device further comprising transmitting an ultrasound request, wherein receipt of an ultrasound response from the at least one of the sink device indicates that the at least one sink device is in the location proximity of the device and available for connection. Aspects of the above device include wherein the ultrasound response can be analyzed by an audio Digital Signal Processor (DSP) for power saving. Aspects of the above device include wherein wirelessly connecting to the at least one sink device includes connecting to the Physical, Media Access Control, and Internet Protocol Layers. Aspects of the above device include wherein streaming further includes wherein streaming to the at least one sink device can begin upon receipt of an input.

Embodiments include a method for communicating with sink devices, the method comprising: sensing, by a processor in a device, a background event, wherein the background event triggers proximity detection for a pre-connect process comprising: automatically scanning, by the processor, a location proximity to the device for device discovery of one or more sink devices; automatically identifying, by the processor, the one or more sink devices found by the scan within the location proximity of the device; automatically wirelessly connecting, by the processor, to at least one sink device of the one or more sink devices identified to have the location proximity to the device; and streaming, by the processor, to the at least one sink device. Aspects of the above method include wherein the sink devices are one or more of a display device, a projector, a speaker, a laptop, a tablet, or a television. Aspects of the above method include wherein the background event is based on a motion sensor, wherein the motion sensor is an accelerometer that senses device movement. Aspects of the above method include wherein the device movement sensed is a distance greater than a pre-determined distance. Aspects of the above method include wherein the background event includes information from a timer. Aspects of the above method include wherein scanning for the one or more sink devices includes searching for a specific Universally Unique Identifier (UUID). Aspects of the above method include wherein the location proximity to the device is in the same room as the device. Aspects of the above method include wherein identifying the one or more sink devices includes checking an Received Signal Strength Indicator (RSSI) value of the one or more sink devices, wherein the one or more sink devices with the RSSI value above a threshold is identified as a candidate to connect to and is at least one sink device. Aspects of the above method further comprising transmitting an ultrasound request, wherein receipt of an ultrasound response from the at least one of the sink device indicates that the at least one sink device is in the location proximity of the device and available for connection. Aspects of the above method include wherein the ultrasound response can be analyzed by an audio Digital Signal Processor (DSP) for power saving. Aspects of the above method include wherein wirelessly connecting to the at least one sink device includes connecting to the Physical, Media Access Control, and Internet Protocol Layers. Aspects of the above method include wherein streaming further includes wherein streaming to the at least one sink device can begin upon receipt of an input.

Embodiments include a non-transitory computer readable medium having instructions thereon that when executed by at least one processor of a device perform a method comprising: sensing, by a processor in a device, a background event, wherein the background event triggers proximity detection for a pre-connect process comprising: automatically scanning, by the processor, a location proximity to the device for device discovery of one or more sink devices; automatically identifying, by the processor, the one or more sink devices found by the scan within the location proximity of the device; automatically wirelessly connecting, by the processor, to at least one sink device of the one or more sink devices identified to have the location proximity to the device; and streaming, by the processor, to the at least one sink device. Aspects of the above media include wherein the sink devices are one or more of a display device, a projector, a speaker, a laptop, a tablet, or a television. Aspects of the above media include wherein the background event is based on a motion sensor, wherein the motion sensor is an accelerometer that senses device movement. Aspects of the above media include wherein the device movement sensed is a distance greater than a pre-determined distance. Aspects of the above media include wherein the background event includes information from a timer. Aspects of the above media include wherein scanning for the one or more sink devices includes searching for a specific Universally Unique Identifier (UUID). Aspects of the above media include wherein the location proximity to the device is in the same room as the device. Aspects of the above media include wherein identifying the one or more sink devices includes checking an Received Signal Strength Indicator (RSSI) value of the one or more sink devices, wherein the one or more sink devices with the RSSI value above a threshold is identified as a candidate to connect to and is at least one sink device. Aspects of the above media further comprising transmitting an ultrasound request, wherein receipt of an ultrasound response from the at least one of the sink device indicates that the at least one sink device is in the location proximity of the device and available for connection. Aspects of the above media include wherein the ultrasound response can be analyzed by an audio Digital Signal Processor (DSP) for power saving. Aspects of the above media include wherein wirelessly connecting to the at least one sink device includes connecting to the Physical, Media Access Control, and Internet Protocol Layers. Aspects of the above media include wherein streaming further includes wherein streaming to the at least one sink device can begin upon receipt of an input.

Embodiments include a system for communicating with sink devices, comprising: means for sensing a background event, wherein the background event triggers proximity detection for a pre-connect process comprising: means for automatically scanning a location proximity to a device for device discovery of one or more sink devices; means for automatically identifying the one or more sink devices found by the scan within the location proximity of the device; means for automatically wirelessly connecting to at least one sink device of the one or more sink devices identified to have the location proximity to the device; and means for streaming to the at least one sink device. Aspects of the above system include wherein the sink devices are one or more of a display device, a projector, a speaker, a laptop, a tablet, or a television. Aspects of the above system include wherein the background event is based on a motion sensor, wherein the motion sensor is an accelerometer that senses device movement. Aspects of the above system include wherein the device movement sensed is a distance greater than a pre-determined distance. Aspects of the above system include wherein the background event includes information from a timer. Aspects of the above system include wherein scanning for the one or more sink devices includes searching for a specific Universally Unique Identifier (UUID). Aspects of the above system include wherein the location proximity to the device is in the same room as the device. Aspects of the above system include wherein identifying the one or more sink devices includes checking an Received Signal Strength Indicator (RSSI) value of the one or more sink devices, wherein the one or more sink devices with the RSSI value above a threshold is identified as a candidate to connect to and is at least one sink device. Aspects of the above system further comprising transmitting an ultrasound request, wherein receipt of an ultrasound response from the at least one of the sink device indicates that the at least one sink device is in the location proximity of the device and available for connection. Aspects of the above system include wherein the ultrasound response can be analyzed by an audio Digital Signal Processor (DSP) for power saving. Aspects of the above system include wherein wirelessly connecting to the at least one sink device includes connecting to the Physical, Media Access Control, and Internet Protocol Layers. Aspects of the above system include wherein streaming further includes wherein streaming to the at least one sink device can begin upon receipt of an input.

The exemplary embodiments are described in relation to peer-to-peer communications between two or more devices using Miracast screencasting. However, it should be appreciated, that in general, the systems and methods herein will work equally well for any type of communication system in any environment utilizing any one or more protocols including wired communications, wireless communications, powerline communications, coaxial cable communications, fiber optic communications and the like.

The exemplary systems and methods are described in relation to transceivers and associated communication hardware, software and communication channels. However, to avoid unnecessarily obscuring the present disclosure, the following description omits well-known structures and devices that may be shown in block diagram form or otherwise summarized.

For purposes of explanation, numerous details are set forth in order to provide a thorough understanding of the present embodiments. It should be appreciated however, that the techniques herein may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communications network and/or the Internet, or within a dedicated secure, unsecured and/or encrypted system. Thus, it should be appreciated that the components of the system can be combined into one or more devices, such as an access point or station, or collocated on a particular node/element(s) of a distributed network, such as a telecommunications network. As will be appreciated from the following description, and for reasons of computational efficiency, the components of the system can be arranged at any location within a distributed network without affecting the operation of the system. For example, the various components can be located in a transceiver, an access point, a station, a management device, or some combination thereof. Similarly, one or more functional portions of the system could be distributed between a transceiver, such as an access point(s) or station(s) and an associated computing device.

Furthermore, it should be appreciated that the various links, including communications channel(s), connecting the elements (which may not be not shown) can be wired or wireless links, or any combination thereof, or any other known or later developed element(s) that is capable of supplying and/or communicating data and/or signals to and from the connected elements. The term module as used herein can refer to any known or later developed hardware, software, firmware, or combination thereof that is capable of performing the functionality associated with that element. The terms determine, calculate and compute, and variations thereof, as used herein are used interchangeably and include any type of methodology, process, mathematical operation or technique.

While the above-described flowcharts have been discussed in relation to a particular sequence of events, it should be appreciated that changes to this sequence can occur without materially effecting the operation of the embodiment(s). Additionally, the exact sequence of events need not occur as set forth in the exemplary embodiments, but rather the steps can be performed by one or the other transceiver in the communication system provided both transceivers are aware of the technique being used for initialization. Additionally, the exemplary techniques illustrated herein are not limited to the specifically illustrated embodiments but can also be utilized with the other exemplary embodiments and each described feature is individually and separately claimable.

The above-described system can be implemented on a wireless telecommunications device(s)/system, such an 802.11 transceiver, or the like. Examples of wireless protocols that can be used with this technology include 802.11a, 802.11b, 802.11g, 802.11n, 802.11ac, 802.11ad, 802.11af, 802.11ah, 802.11ai, 802.11aj, 802.11aq, 802.11ax, 802.11u, WiFi, LTE, LTE Unlicensed, 4G, Bluetooth®, WirelessHD, WiGig, Wi-Fi Direct®, Miracast, 3GPP, Wireless LAN, WiMAX.

The term transceiver as used herein can refer to any device that comprises hardware, software, firmware, or combination thereof and is capable of performing any of the methods described herein.

Additionally, the systems, methods and protocols can be implemented on one or more of a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a modem, a transmitter/receiver, any comparable means, or the like. In general, any device capable of implementing a state machine that is in turn capable of implementing the methodology illustrated herein can be used to implement the various communication methods, protocols and techniques according to the disclosure provided herein.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Broadcom® AirForce BCM4704/BCM4703 wireless networking processors, the AR7100 Wireless Network Processing Unit, other industry-equivalent processors, and may perform computational functions using any known or future-developed standard, instruction set, libraries, and/or architecture.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with the embodiments is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and telecommunications arts.

Moreover, the disclosed methods may be readily implemented in software and/or firmware that can be stored on a storage medium, executed on programmed general-purpose computer with the cooperation of a controller and memory, a special purpose computer, a microprocessor, or the like. In these instances, the systems and methods can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications transceiver.

It is therefore apparent that there has been provided systems and methods for a repartitioned Miracast architecture with a pre-connect and stream mechanism. While the embodiments have been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this disclosure.

1. A device, comprising:
a memory;
a transceiver; and
a processor, the processor configured to:
sense a background event, wherein the background even triggers a pre-connect process for proximity detection comprising:
automatically scan a location proximity to the device for device discovery of one or more sink devices;
automatically identify the one or more sink devices found by the scan within the location proximity of the device;
automatically wirelessly connect to at least one sink device of the one or more sink devices identified to have the location proximity to the device; and
stream to the at least one sink device.

2. The device of claim 1, wherein the sink devices are one or more of a display device, a projector, a speaker, a laptop, a tablet, or a television.

3. The device of claim 1, wherein the background event is based on a motion sensor, wherein the motion sensor is an accelerometer that senses device movement.

4. The device of claim 3, wherein the device movement sensed is a distance greater than a pre-determined distance.

5. The device of claim 1, wherein the background event includes information from a timer.

6. The device of claim 1, wherein scanning for the one or more sink devices includes searching for a specific Universally Unique Identifier (UUID).

7. The device of claim 1, wherein the location proximity to the device is in the same room as the device.

8. The device of claim 1, wherein identifying the one or more sink devices includes checking an Received Signal Strength Indicator (RSSI) value of the one or more sink devices, wherein the one or more sink devices with the RSSI value above a threshold is identified as a candidate to connect to and is at least one sink device.

9. The device of claim 8, further comprising transmitting an ultrasound request, wherein receipt of an ultrasound response from the at least one of the sink device indicates that the at least one sink device is in the location proximity of the device and available for connection.

10. The device of claim 9, wherein the ultrasound response can be analyzed by an audio Digital Signal Processor (DSP) for power saving.

11. The device of claim 1, wherein wirelessly connecting to the at least one sink device includes connecting to the Physical, Media Access Control, and Internet Protocol Layers.

12. The device of claim 1, wherein streaming to the at least one sink device can begin upon receipt of an input.

13. A method comprising:
sensing, by a processor in a device, a background event, wherein the background event triggers a pre-connect process for proximity detection comprising:
automatically scanning, by the processor, a location proximity to the device for device discovery of one or more sink devices;
automatically identifying, by the processor, the one or more sink devices found by the scan within the location proximity of the device;
automatically wirelessly connecting, by the processor, to at least one sink device of the one or more sink devices identified to have the location proximity to the device, and
wherein wirelessly connecting to the at least one sink device includes connecting to the Physical, Media Access Control, and Internet Protocol Layers; and
streaming, by the processor, to the at least one sink device.

14. The method of claim 13, wherein the background event is based on a motion sensor, wherein the motion sensor is an accelerometer that senses device movement, and wherein the device movement sensed is a distance greater than a pre-determined distance.

15. The method of claim 13, wherein scanning for the one or more sink devices includes searching for a specific Universally Unique Identifier (UUID).

16. The method of claim 13, wherein the location proximity to the device is in the same room as the device.

17. The method of claim 13, wherein identifying the one or more sink devices includes checking an Received Signal Strength Indicator (RSSI) value of the one or more sink devices, wherein the one or more sink devices with the RSSI value above a threshold is identified as a candidate to connect to and is at least one sink device, and further comprising transmitting an ultrasound request, wherein receipt of an ultrasound response from the at least one of the sink device indicates that the at least one sink device is in the location proximity of the device and available for connection.

18. A non-transitory computer readable medium having instructions thereon that when executed by at least one processor of a device perform a method comprising:
sensing, by a processor in a device, a background event, wherein the background event triggers a pre-connect process for proximity detection comprising:
automatically scanning, by the processor, a location proximity to the device for device discovery of one or more sink devices;
automatically identifying, by the processor, the one or more sink devices found by the scan within the location proximity of the device;
automatically wirelessly connecting, by the processor, to at least one sink device of the one or more sink devices identified to have the location proximity to the device; and
streaming, by the processor, to the at least one sink device.

19. The non-transitory medium of claim 18, wherein the background event is based on a motion sensor, wherein the motion sensor is an accelerometer that senses device movement, and wherein the device movement sensed is a distance greater than a pre-determined distance.

20. The non-transitory medium of claim 18, wherein identifying the one or more sink devices includes checking an Received Signal Strength Indicator (RSSI) value of the one or more sink devices, wherein the one or more sink devices with the RSSI value above a threshold is identified as a candidate to connect to and is at least one sink device, and further comprising transmitting an ultrasound request, wherein receipt of an ultrasound response from the at least one of the sink device indicates that the at least one sink device is in the location proximity of the device and available for connection.
